(19) United States
(12) Patent Application Publication
(10) Pub. No.: US 2018/0039736 A1
(43) Pub. Date: Feb. 8, 2018

(54) System and Method for Automated Tracking and Analysis of Pharmaceutical Use within Healthcare Facilities

(71) Applicant: Alicia Williams, New York, NY (US)

(72) Inventor: Alicia Williams, New York, NY (US)

(21) Appl. No.: 15/237,856

(22) Filed: Aug. 16, 2016

Related U.S. Application Data
(60) Provisional application No. 62/371,949, filed on Aug. 8, 2016.

(51) Int. Cl. G06F 19/00

(52) U.S. Cl. CPC G06F 19/322; G06F 19/3456; G06F 19/328

(57) ABSTRACT

This invention discloses a novel system and method for monitoring the use of prescription drugs in a clinical setting in order to predict drug usage and drug purchasing requirements as well as monitor waste and diversion of drugs from the clinical environment.

### PRIORITY CLAIM

This utility application claims priority to U.S. Provisional Application No. 62/371,949 filed on Aug. 8, 2016.

### FIELD OF INVENTION

The present invention generally relates to the field of data collection techniques in the field of medicine related to prescription drug use tracking. The system and method assists hospitals with accurately identifying opportunities for drug cost savings and identifying drug diversion patterns within their institutions. “Diversion” is a term that refers to giving medication, keeping medication that has been dispensed from the patient or not administrating the dispensed drug. Diversion includes actions that constitute illicit access to drugs by abusing the drug prescribing and delivery system.

### BACKGROUND

New developments in the field of medicine provide for using different data processing systems for purchasing drugs for medical care providers, for example, hospitals, and data processing systems for storing information about a patient's treatment. In addition, other data processing systems provide a mechanism for dispensing drugs to a care-giver. However, in the midst of the busy clinical environment, it is difficult for hospital management to accurately predict trends in drug purchasing in order to effectively purchase the drugs either with sufficient lead-time to meet demand requirements or to meet budget requirements. In addition, in the busy clinical environment, there are often situations where certain prescription drugs may be wasted or diverted—which costs the hospital money and may also be illegal. Hospitals are losing money with drug expenditures due to increasing drug costs and medication expiration and waste. Drug diversion is a problem that can prove costly for health systems in terms of drug loss, high regulatory fines and lawsuits. Drug diversion poses a serious threat to hospitals, outpatient clinics, and the overall quality of patient care. Managing costs within the hospital drug supply chain is key for healthcare systems to provide value-based care to their patients. Therefore, there is a need for a system and method to monitor all of the disparate data being generated by the individual data systems that are used in a clinical setting in order to properly manage prescription drug purchasing and policing the diversion of such drugs in the busy clinical environment. The system and method dramatically improves the tracking of pharmaceutical products acquired, dispensed ordered and administered within health systems. The system provides hospitals with acquisition statistics for specific drug items and compares those numbers against the quantity of these drugs actually administered to patients. For the mid to large size health system, the system will improve the overall reporting accuracy of drug usage across the hospital enterprise. The technology will help identify opportunities to reduce waste and unnecessary use of specific drug items, thus minimizing the financial loss that may be associated. Improved capture and tracking of drug items to patients will also enable hospitals and health systems to document dispensations of medications to patients that fall under 340B eligibility. The 340B Pricing Drug Program provides for significant cost savings for healthcare institutions that provide care to patients that meet the 340B program requirements. Hospitals can replenish inventory dispensed to patients under this program at a significant discount—in some cases close to 50% in savings. Thus, accurate documentation of dispensing of these specific drug items to the 340b patient is of high importance in providing cost savings and ensuring compliance with federal 340b program regulations.

### DESCRIPTION OF THE FIGURES

The headings provided herein are for convenience only and do not necessarily affect the scope or meaning of the claimed invention. In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced (e.g., element 204 is first introduced and discussed with respect to FIG. 2).

FIG. 1. Shows a basic system components

FIG. 2. Flowchart for report generation for removals, returns, wastes and inventory

FIG. 3 Example display screen daily activity.

FIG. 4 Flowchart for removal report generation

FIG. 5 example display screen for high user report

FIG. 6 example display screen for high user vs. medical orders

FIG. 7 example display screen for high user vs. administration

FIG. 8 example display screen for high user vs. user attendance

FIG. 9 Flowchart for return/waste audit

FIG. 10 example display screen for return/waste audit report

FIG. 11 Flowchart for medical override report

FIG. 12 example display screen for medical override report

FIG. 13 flowchart for medication discrepancy report

FIG. 14 example display screen for medication discrepancy report

FIG. 15 flowchart for random comparison

FIG. 16 example screen for random comparison report.

FIG. 17 flowchart for par optimization report

FIG. 18 example display screen for par optimization

FIG. 19 example display screen for an alert

FIG. 20 example display screen for inventory watch list.

FIG. 21 example display screen for inventory report

FIG. 22 example display screen for medication usage

FIG. 23 example display screen for dispense v. administrated report.

FIG. 24 example display screen for dispensing statistics.

FIG. 25A and FIG. 25B are the components of an exemplary data entry table from an ADC.

FIG. 26A and FIG. 26B Example data dependency tables

### DETAILED DESCRIPTION

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention can include many other features not described in detail herein. Additionally, some well-known structures or functions may not be shown or described in detail below, so as to avoid unnecessarily obscuring the relevant description. The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

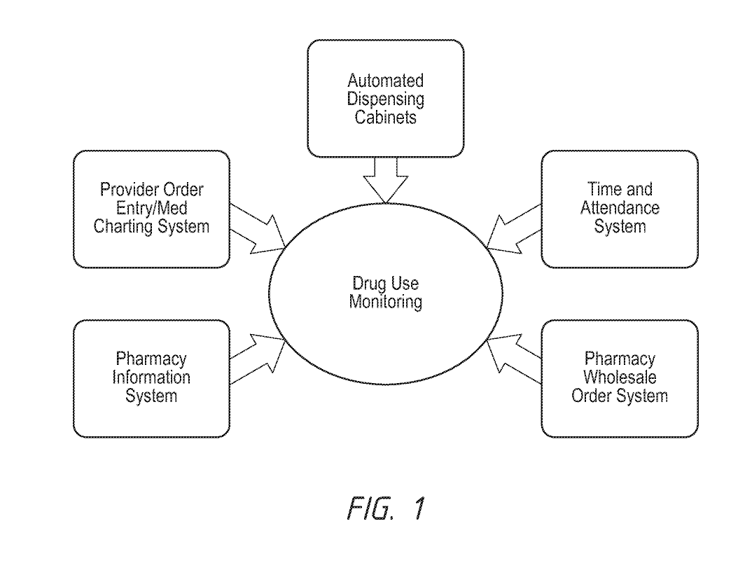

The invention is capable of detecting medication theft and anomalous patterns of drug use. By being integrated with multiple clinical information systems and wholesaler systems, the invention receives medication order data (dose, route, patient, frequency), medication documentation data from nursing administration systems and drug removal data from automated dispensing cabinets. Drug theft can be detected more readily than systems that rely on data collected within only one application area in the hospital. In addition, the invention provides cost savings in medication inventory. By receiving data from pharmacy wholesaler systems on medication orders and quantities of drugs ordered by the pharmacy storeroom to supply the hospital facility. Information is collected on each drug item ordered and is matched against the actual usage of the item, as determined by the quantity of drugs actually administered to patients over a given time period. To operate the invention, the system receives input from different types of hospital personnel, for example, a system administrator, a pharmacy manager, a nurse manager, a storeroom technician as well as the caregivers attending to the patient, obtaining the drug from the local drug cabinet and administrating the drugs. See FIG. 1. The invention output reports on trends of controlled substance drug use, e.g. drug diversion reports. The invention can also be used for tracking pharmaceutical inventory orders and dispensing to pharmacy satellites with a hospital system with multiple clinical locations. By using the invention, real-time updates of data provide immediate and current analytical results. Yet another application of the invention is to charge capture application of medications used in ambulatory and operating room procedure areas—which occurs often but without proper tracking into the hospital billing system. This charge capture will also enable the application to track dispensations of 340b medications that are dispensed to eligible patients and allow for replenishment of these drugs at 340b pricing.

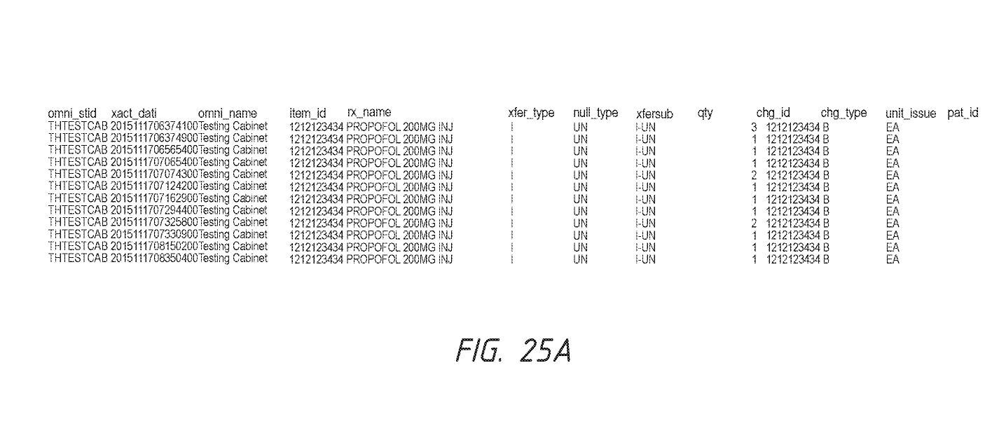

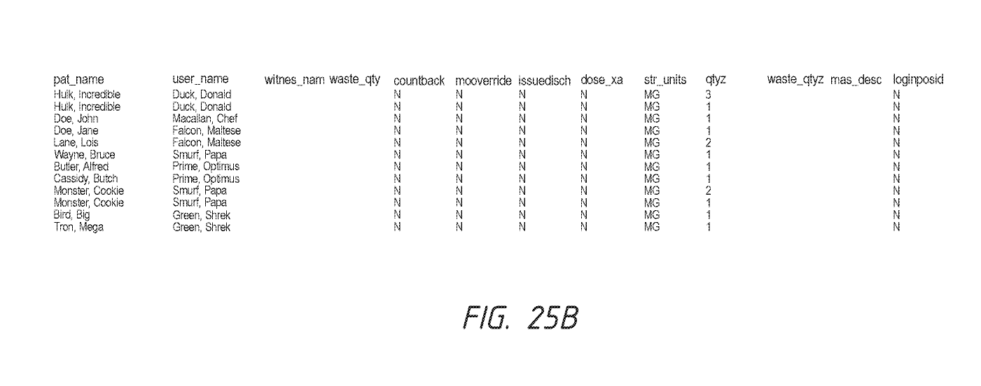

The method and system operates using typical hospital data systems. Most hospitals and health data systems track the purchase, dispensing, ordering and administration of drug products using multiple clinical and procurement applications, for example drug wholesaler ordering systems, Computerized Provider Order Entry systems (CPOE), Pharmacy Information Systems (PIS), Automated Dispensing Cabinets (ADC) and Electronic Medical Record systems (eMAR). The drug wholesaler ordering system can be a system where supply orders for Pharmacy inventory can be submitted and invoices for orders can be tracked and documented. The CPOE can be a system that receives commands to place medication orders for drugs to be supplied to a patient. The PIS can be a pharmacy management system that tracks physician orders for a drug, its delivery to the patient and submission of billing information for the patient. The ADC is a location where drugs are dispensed to the healthcare staff and that tracks the dispensing of the drugs. An exemplary set of data records from an ADC is shown in FIGS. 25A and 25B. Each row represents a dispensing transaction, for which the drug identifier, medical order number clinical user name or identifier, and the destination patient name or identifier is entered. The eMAR is an electronic medical record management system that stores data about a patient's treatment. For example, the eMAR may contain the patient name or identifier, a clinical user name or identifier, a drug name or identifier, an amount administered and confirmation that the drug was administered, along with a time stamp. The comparison of data from each of these systems can prove time-consuming for users as well as limiting in that all data related to pharmaceutical use within a hospital is not consistently captured. The system obtains data from wholesaler ordering systems, CPOE, PIS and ADC systems, and operates analytics on the multiple sources of data in order to provide meaningful reports and a documentation repository to indicate opportunities for cost savings for hospitals as well as identify anomalous use of controlled or expensive drugs that may indicate drug diversion.

The data source associated with Automated Dispensing Cabinet (ADC) systems provides data about the dispensing of drugs. The dispensing data may include drug removals, returns, wastes, inventory counts and count discrepancies. The data may be represented as tables in a larger database, as shown in FIGS. 25A and B. Each subsystem may contribute the data that appears in a table. The Computerized Provider Order Entry System (CPOE) provides data about medication orders for patients and patient drug allergies. The Medication Documentation System is drug administration data typically derived from electronic Medication Administration Record (eMAR). This data includes a record of medication doses actually given to patient as per physician order. The Pharmacy Wholesaler Systems include Purchase Orders and Invoices from Pharmacy distributors for Pharmacy inventory.

A. In one embodiment, an ADC data record (FIG. 25A, 25B) may include the following entries for each patient in the hospital unit that the ADC services:
a. Patient Identifier
   i. Patient Name
   ii. Patient Visit Number (Account Number)
   iii. Patient Medical Record Number
   iv. Patient Location (Nursing Unit)
   v. Patient Type
b. Drug Name
c. Drug ID—usually hospital specific—link between item files in Pharmacy Information System, ADC and Billing Systems
d. Medication Removals (which are confirmations of removal of the drug from the cabinet)
e. Medication Returns to ADCs
f. Medication Wastes at ADCs
g. Inventory Count of Drug Items stocked in ADCs
h. Medication Discrepancies (which is the difference in quantity of drug on record vs. quantity of drug actually counted by nurse)
i. Order ID number
j. User ID (the person obtaining the drug dose).

B. In one embodiment, the CPOE data record may contain:
a. Patient Identifiers
   i. Patient Name
   ii. Patient Visit Number (Account Number)
   iii. Patient Medical Record Number
   iv. Patient Location (Nursing Unit)
   v. Patient Bed
   vi. Patient Type
b. Order ID Number
c. Item ID
d. Drug Name (Description)
e. Route of Administration (e.g. by mouth, intravenous)
f. Frequency of Order (e.g. once daily, twice daily)
g. Duration of Order (e.g. 14 days, 30 days)
h. Start Time
i. Stop Time

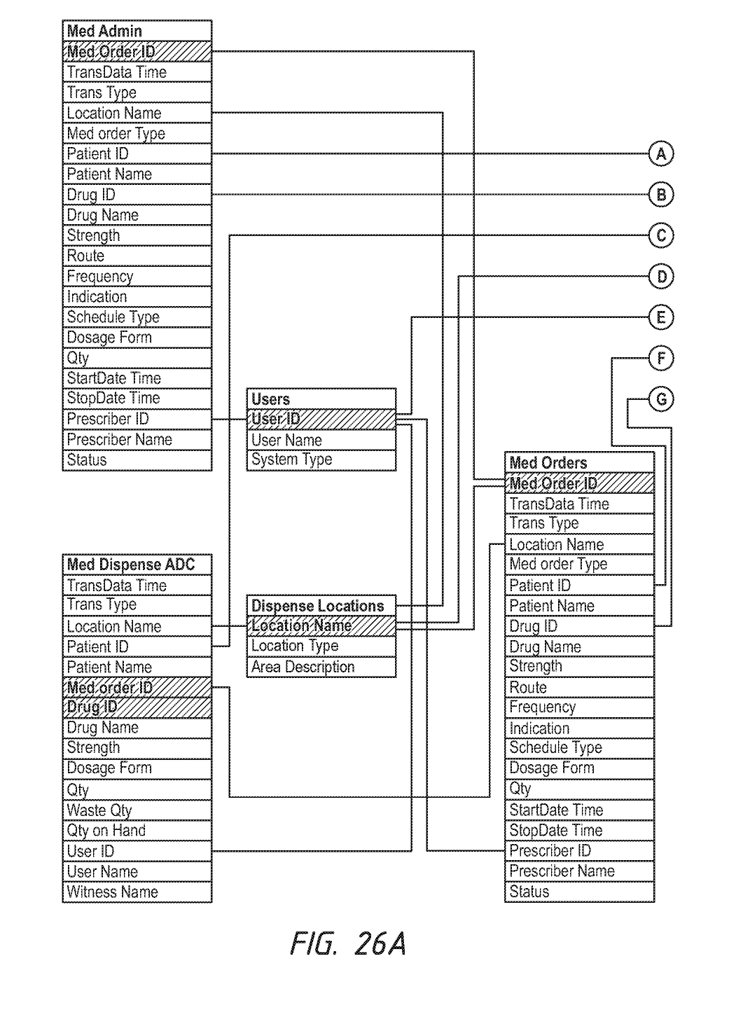

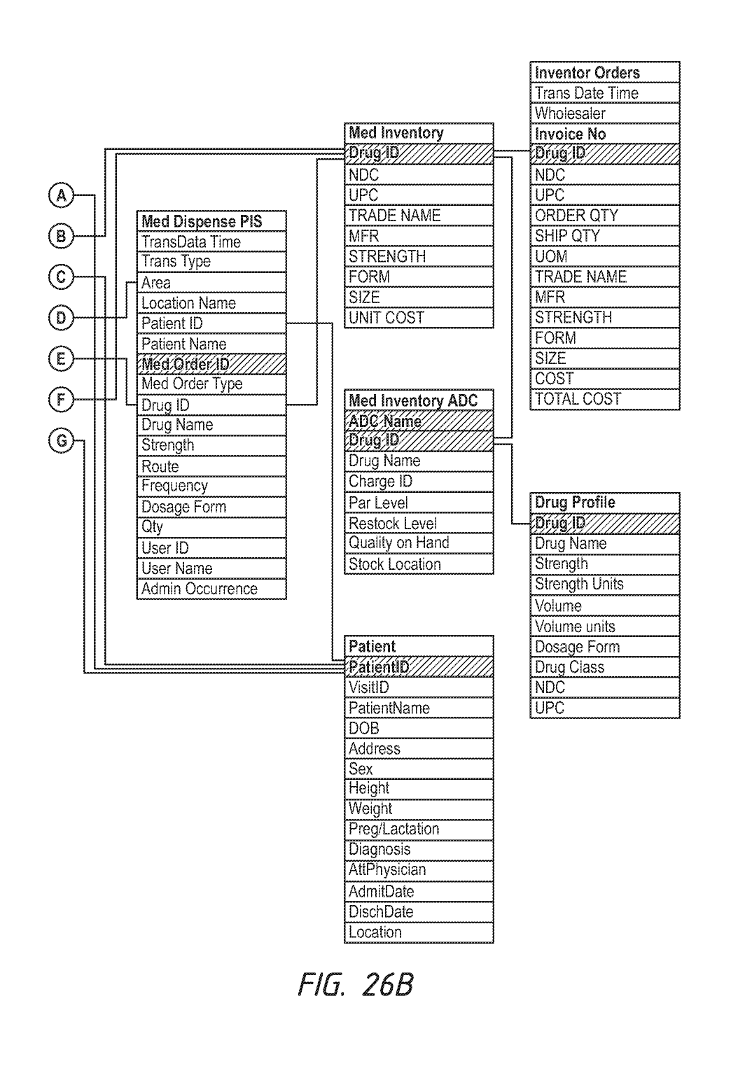

C. In one embodiment of the invention, each patient record in the Electronic Medication Administration Record (eMAR) may contain:
a. Patient Identifiers
   i. Patient Name
   ii. Patient Visit Number (Account Number)
   iii. Patient Medical Record Number
   iv. Patient Location (Nursing Unit)
   v. Patient Bed
   vi. Patient Type
b. Order ID Number
c. Drug Name
d. Route of Administration (e.g. By mouth, intravenous)
e. Frequency of Order (e.g. once daily, twice daily)
f. Duration of Order (e.g. 14 days, 30 days)
g. Administration Times for Medications (which can include confirmation of administration of the drug.)
h. User ID (the practitioner administrating the drug.)
i. Drug ID
   FIGS. 26A and 26B depict exemplary data dependencies between the different sources of data and their interrelationships in the system.

ANALYTICAL PROCESSES: The analytics module will analyze drug usage patterns and offer prompt detection of abnormal trends in medication usage so that healthcare providers can quickly take action towards ending anomalous activity. The invention proves will have the following basic functionality for reporting for all users:
Tracking of drug removals from Automated Dispensing Cabinets (ADC).
Matching of drug removals from ADC data with doses ordered by provider in CPOE system
Matching of drug removals in ADC data with doses documented as administrated to patient on electronic Medication Administration Record (eMAR).
Matching shifts worked by Nurse from the personnel time and attendance system against Nurse's activity records.within the ADC and eMAR systems.

The system operates data processes that analyze historical dispensing and administration transactions to do the following:
1. Identify drug items which the hospital may be over-purchasing and predict future spending.
2. Identify drug items that may be currently diverted by clinical staff (Nursing) and identify where and when the diversion activity by a user is likely to occur.
3. Identify and track drug items that are dispensed to patients that also qualify for replenishment at the lower 340B price, providing additional cost savings for hospitals.

The system generates data output comprising reports that utilize predictive analytics based on the identity of the drug (either by the Drug ID number or the Drug Name), the Nursing Unit or Nursing service (i.e. a group of Multiple Nursing Units). In one embodiment, the system retrieves 30 days of dispensing transaction data from the Automated Dispensing Cabinet (ADC) system. The system then retrieves 30 days of dispensing transaction data from Pharmacy Information System (PIS). In some cases, the PIS data shows that the drug was directly delivered to patient, not through the ADC system. The system uses the Order ID Number from dispense transactions from ADC and PIS systems and uses them as keys to compare the order data to the electronic Medication Administration Record (eMAR) transactions that show drugs be administered. For each transaction in the ADC, the system determines whether the Order ID in the ADC transaction list matches up with the same Order ID in the eMAR record, and if so, whether the drug was administered. The drug transaction for the PIS are managed similarly.
The invention searches through the eMAR transactions with the same Order ID number.
The system creates a table for each drug merging the dispense transactions and the eMAR transactions. In another embodiment, there is one table for all drug transactions.
The system then counts the number of transaction records that have an indicator stating that the medication was given to a patient.
The system counts the number of transaction records in this table that have an indicator showing an administration status as Not Given or Null. Null may mean that the drug was given. but wasn't documented at the particular time specified by the occurrences listed in the order system. The number of transactions in a patient's eMAR for a particular drug will be defined by the order itself. A given drug may be prescribed with several occurrences, and each should be indicated in the eMAR data as administered or not.

The different sources of data from the various systems the healthcare provider operates are used to drive different analytical calculations. In one embodiment, the system calculates over all patients for a specific drug: [(dispensed by ADC+direct PIS delivery to patient)−(patient eMAR indicates Admin=YES)]. This result represents the quantity of the selected drug that was not given to patients or was not credited back to patients' accounts in the billing system. This value could be a running sum, updated on each transaction, or it could be executed in batch. The result confirms that the amount dispensed are associated with actual administrations to the patient—if the number is zero. However, a non-zero amount can be checked to see how different it is from (patient eMAR indicates YES).

In yet another embodiment, the system calculates over all of the patients for a specific drug:

[(Dispensed with Admin=YES)*Dollar Value of Drug Item for dosage]=Total Dollar Value of that drug Given to all of the Patients during period of data set. This result represents the value of the selected drug that was actually given to patients and therefore what the cost of proper administration of the drug.

In yet another embodiment, the system calculates over all of the patients for a specific drug:

(Total quantity of drug dispensed indicated by ADC)*Dollar Value of Drug Item=Total Cost of that drug item Dispensed for Time Period. This result is usable in practice areas where there are no eMAR administrating indications. For example, in an operating room environment or emergency room, where drugs are administered without a formal order identifier because of the urgency of the care.

The system can take a sample of data and determine an average value to the results and a standard deviation. These can be used to predict expected total amounts of a drug or to correlate usage with other factors, for example, time of year, local population and other predictive variables. In another embodiment, a predetermined threshold value can be set for expected drug usage. When this threshold is exceeded, an alarm indication signal can be generated and an alarm message delivered to a predetermined destination, for example, by an automatically generated email or text message. For example the first analytic may be run continuously, with a goal of being zero at all times, but in fact with some predetermined level of acceptable discrepancy where the dispensed drug is not administrated to the patient. When that discrepancy value exceeds a predetermined level, the alarm may be triggered. The level may depend on the type of drug. For example, a threshold for an antibiotic may be higher than that for an opioid that is subject to illicit diversion.

In yet another embodiment, a sampling strategy may be used to detect transients in usage or for predicting cost trends. In this embodiment, the system runs the first analytic calculations on 30, 60 and 90 day samples of data. The user may also define the date and time range for the data sample. Where an uptrend is detected in the non-administered dosages that were dispensed, this may indicate diversion. The system can then use data filtering to correlate the detected trend with a hospital department or even a hospital employee.

In yet another embodiment, the multiple sampling strategy may be used to correlate increased usage of a drug with an increased number of patients with a particular condition. The patient's condition may be determined by string-searching the eMAR for patients whose diagnosis description contains certain words. In this embodiment, the system can collect 30, 60, and 90 days of transactions, and using the second analytic, determine the average number of patient admissions with active medication orders for these drugs whether there will be an upward or downward trend in cost of the drug to the hospital facility. The system will detect the actual cost of the historical usage and predict the future financial loss or gain from future use of the drug in these specific patient areas.

The system can also use the multiple time window data sampling to predict transactions using third analytic. In this embodiment the system can predict given the average number of patient admissions whether there will be an upward or downward trend in the cost of the drug to the hospital facility. This analytic perioperative areas (Operating Rooms and Recovery Rooms) and outpatient areas and therefore uses consumption data as well. This data may also be used for tracking of 340B drug dispensations to outpatients. These particular dispensations can be tracked, counted and allocated by drug NDC number to ensure the facility's compliance with the 340B Drug Pricing Program regulations.

When the system analyzes the data and detects anomalies, for example, transients in usage, or spikes in Admin=NO, then this data can automatically trigger further investigation. This can include using the system to filter the transactions that generated the spike to determine if most of that data is associated with one particular practitioner number or hospital department. Typically, the User ID from the ADC should match the UserID administrating the drug. Where there is persistent discrepancy discovered in the data, for example, by an analytic that determines the relative number of matches in UserID for a given hospital department, this may be investigated. This can also be correlated with the type of drug (e.g. controlled substance or not). In yet another embodiment, the system can summarize drug use in such a way as to report to a central facility its typical usage of a particular drug as well as information about the community the hospital services, i.e. the number of beds, the size of the city. This data may be used by the system to determine if a different hospital's usage of the same drug is relatively the same as the first hospital's or much different and therefore subject to investigation. Similarly, the hospital can utilize correlations across the eMAR to determine what types of treatment correlate with usage of a particular drug, for example, painkillers as applied to elective surgery as compared to emergency surgery. The system can also be used to correlate drug use data with personnel data.

In yet another embodiment, when the system detects a dispensing of a selected drug associated with a UserID, it can check whether according to the personnel system, that person was present for their shift or off duty. Where the drug is a highly controlled substance, say an opioid, the dispensing of the drug to an off-duty staff member may be worth investigating, or at least logging to see if this is a persistent behavior.

### Analytical Reports

The system provides an extensive library of analytic report output, all geared towards accurate tracking of daily activities related to controlled substance use and associated costs of utilization.

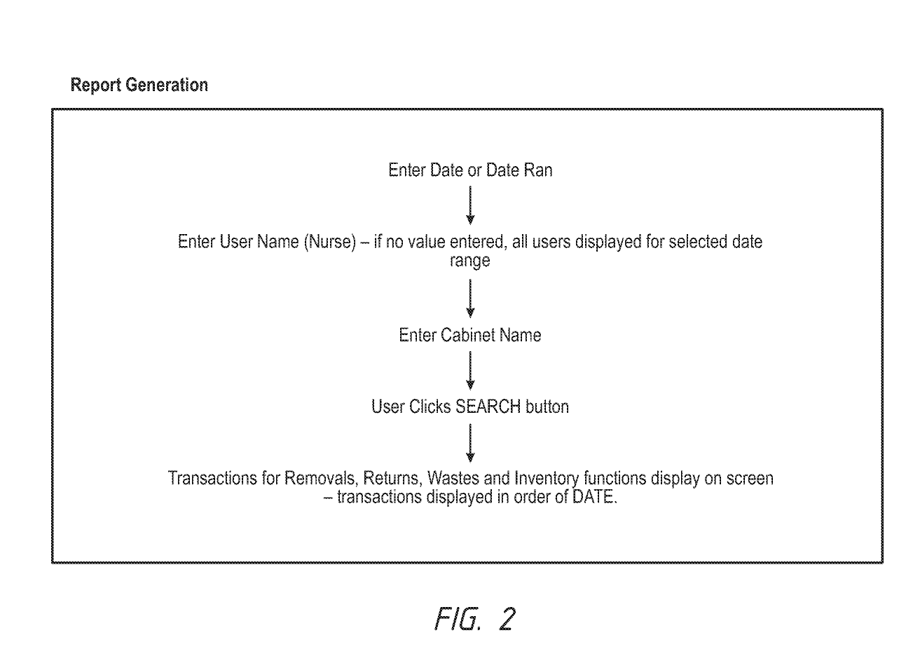

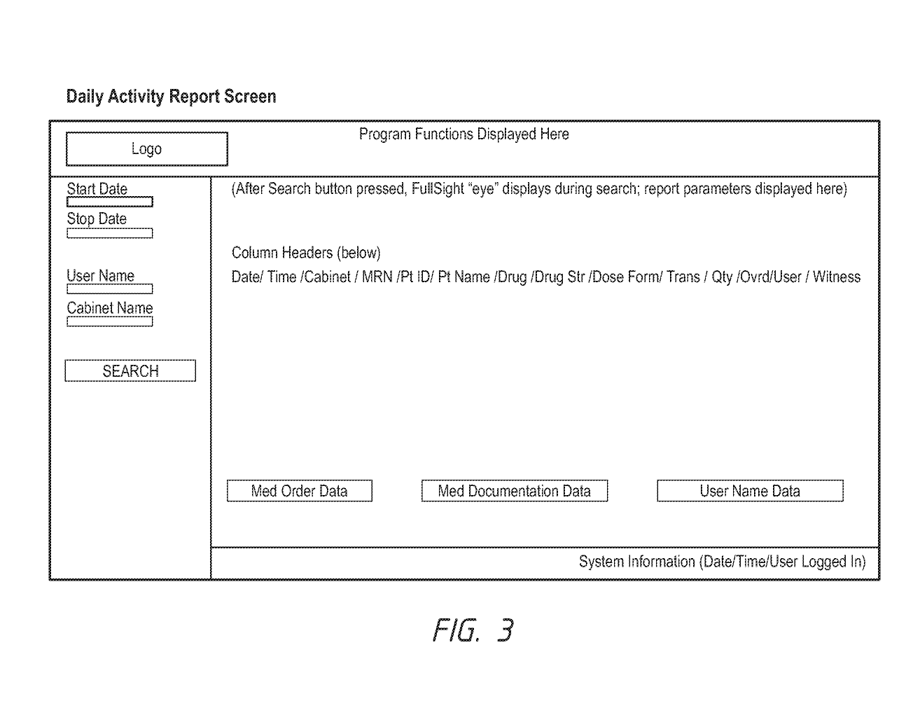

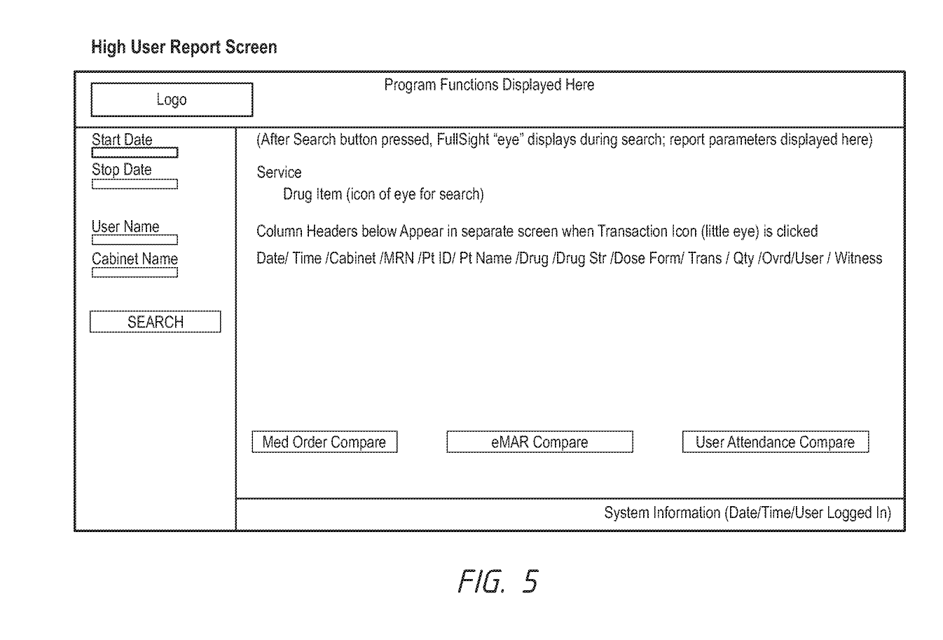

Tracking and Trending Reports.
1. Daily Activity (Removals, Wastes, Returns, Inventory) FIG. 2 shows an example flowchart for generating reports for Removals, Returns, Waste and Inventory functions. The output of the report generation is shown in FIG. 3.
2. High User Reports (Drug Prices included in reports). FIG. 5 is an example output of this report.
3. Return/Waste Audit
4. Medication Overrides—medications removed with a physician's order
5. Medication Discrepancies
6. Random comparison search—One user's removal patterns compared with 10 other users in same service—Same service comparison needed—patterns of medication doses ordered will be similar—comparison will be more indicative of appropriate use.
7. High User Comparison Reports—reports compares user removals from Automated Dispensing Cabinets against medication orders for patient, user documentation of medications given and work attendance of the user.
   a. High User vs. Med Orders
   b. High User vs. Med Administration
   c. High User vs User Attendance

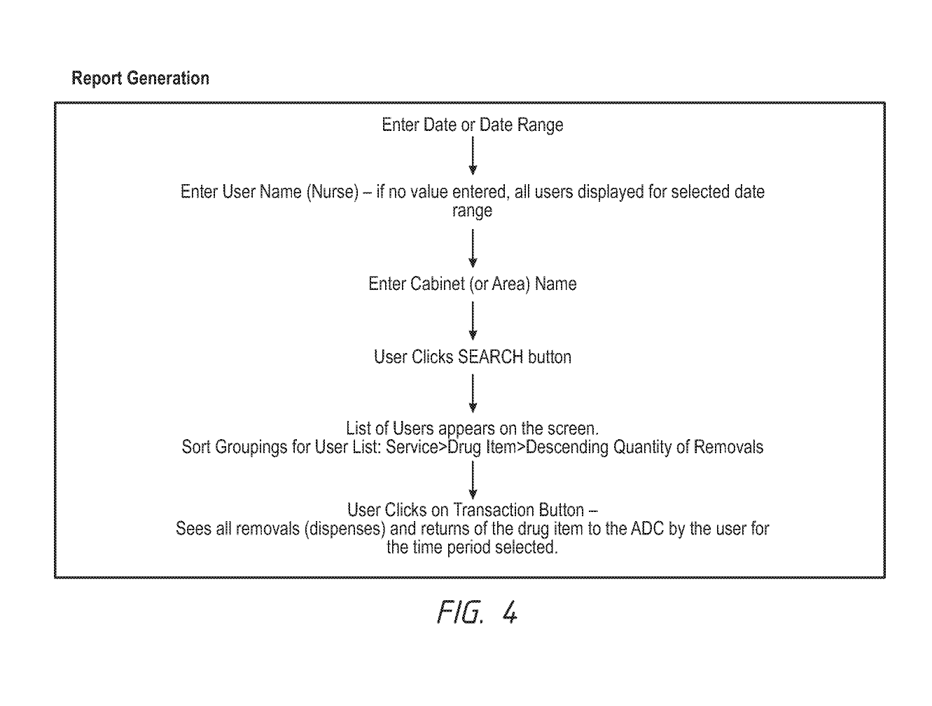

1. The Daily Activity Report displays daily removals of drug items from Automated Dispensing Cabinets. FIG. 4 shows a flowchart for generating the report. Report also displays returns of drug items to cabinets, wasting of drug items (for partial doses) and inventory (or counting) of drug items in the cabinet. The person running the report can filter the data on transaction type. The person running the report can click on column header to sort by ascending or descending values.

This report has the following fields and data types:
Date (MM/DD/YYYY)
Time (00:00-24:00)
Patient ID (Visit Number) (number)
Patient Medical Record Number (number)
Patient Name
Cabinet Name (Alpha Numeric)
Drug Name (text)
Drug Strength (number)
Drug Dosage Form (text)
Transaction Type (Removal, Return, Waste, Inventory) (Text)
Transaction Qty (Number)
Med Override (if applicable) (text)
User Name (text)
Witness Name (if required on transaction) (text)

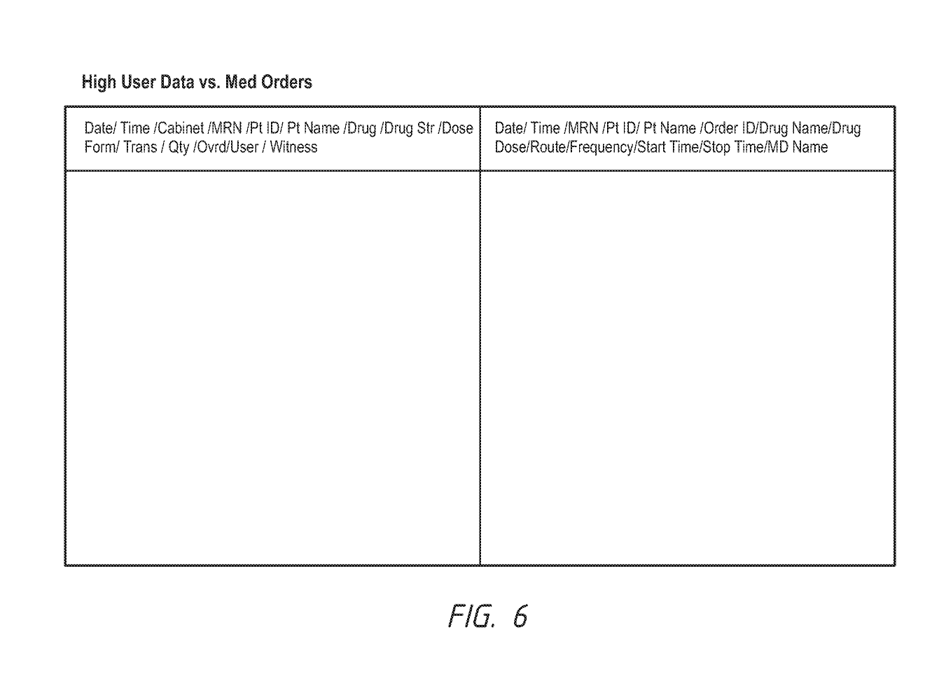

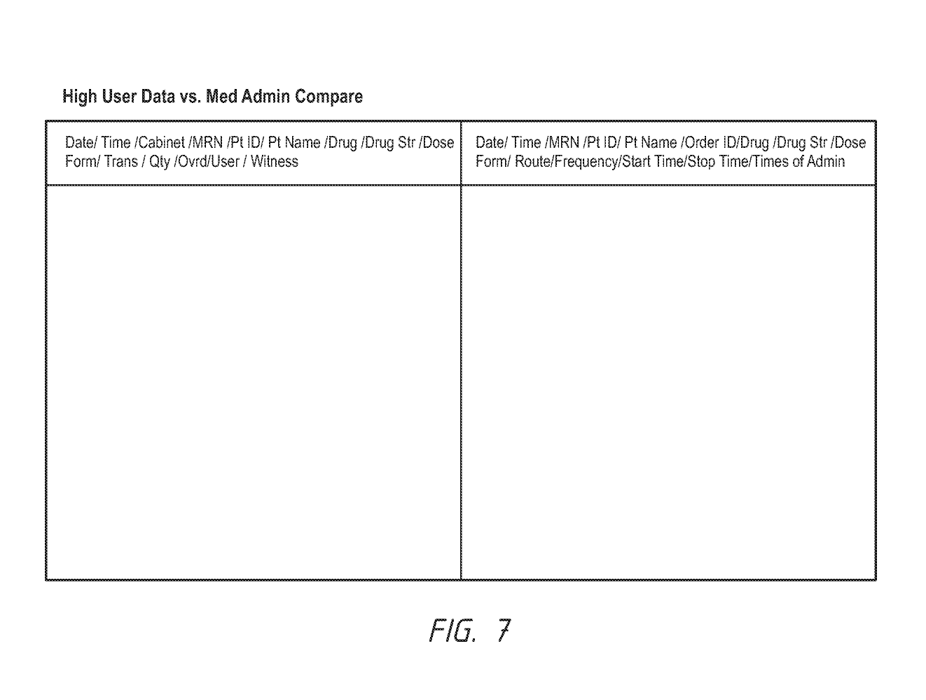

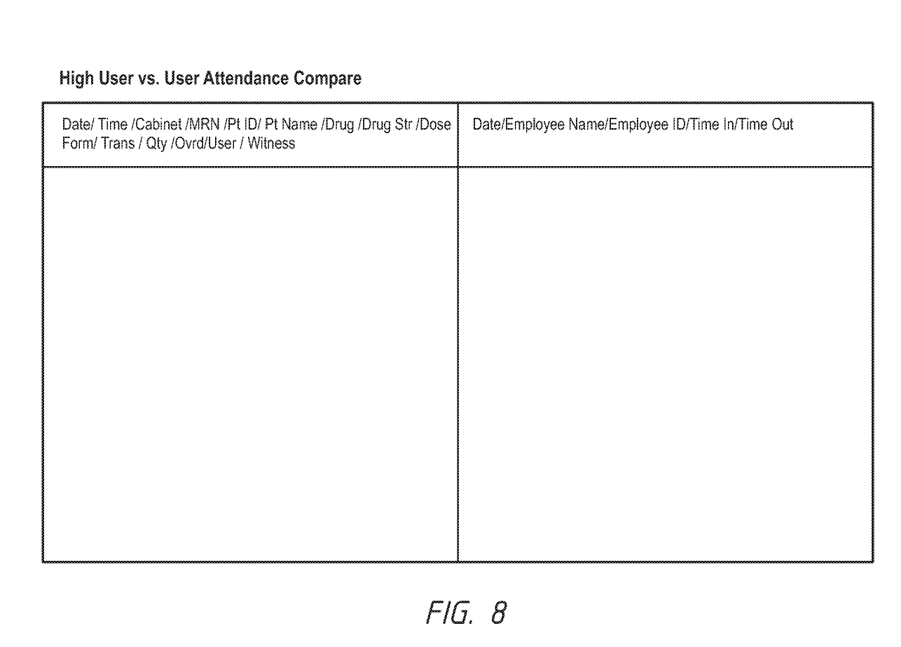

2. High User Activity Report: This report, FIG. 5, displays transactions in which a user issued larger quantities of a medication than other users during the same timespan. This report looks at total dispenses over time to identify a trend in removal patterns. The report is sorted by Area or Service, then by drug item. When running the report, the option to show the Medication Order Data and Medication Administration History is present. The standard deviation setting by default is two deviations from the average. The standard deviation can be selected by the facility. The threshold is the number of issues a user must reach before they are included on the report. The report indicates the average number of issues for all users for the time period selected. This report is used to look for users who dispense large quantities of a drug item and review the medication order and administration data to determine whether the number of removals were appropriate. A split screen, FIG. 6, shows the High User data matched against medical orders from the EMR. A split screen, FIG. 7, appears where the person running the report can select the date and time range for the medication order and administration data so that they can view all information related to the ordering, dispensing and administration on one screen. A split screen, FIG. 8, shows the High User data matched against User Attendance obtained from personnel data records. The report indicates all removals (dispenses) and returns of the drug item to the ADC by the user for the time period selected.

### Report Use

### Service List: Medical/Surgical Critical Care Behavioral Health

### Obstetrics and Gynecology

### Pediatrics

### Other (Defined by Site)

### Drug List:

Uploaded from ADC system formulary

### Fields Displayed and Data Types for Report:

Date (MM/DD/YYYY)
Time (00:00-24:00)
Patient ID (Visit Number) (number)
Patient Medical Record Number (number)
Patient Name (text)
Cabinet Name (Alpha Numeric)
Drug Name (text)
Drug Strength (number)
Drug Dosage Form (text)
Transaction Type (Removal, Return, Waste, Inventory) (Text)
Med Override (if applicable) (Text)
User Name (text)
Witness Name (if required on transaction) (text)

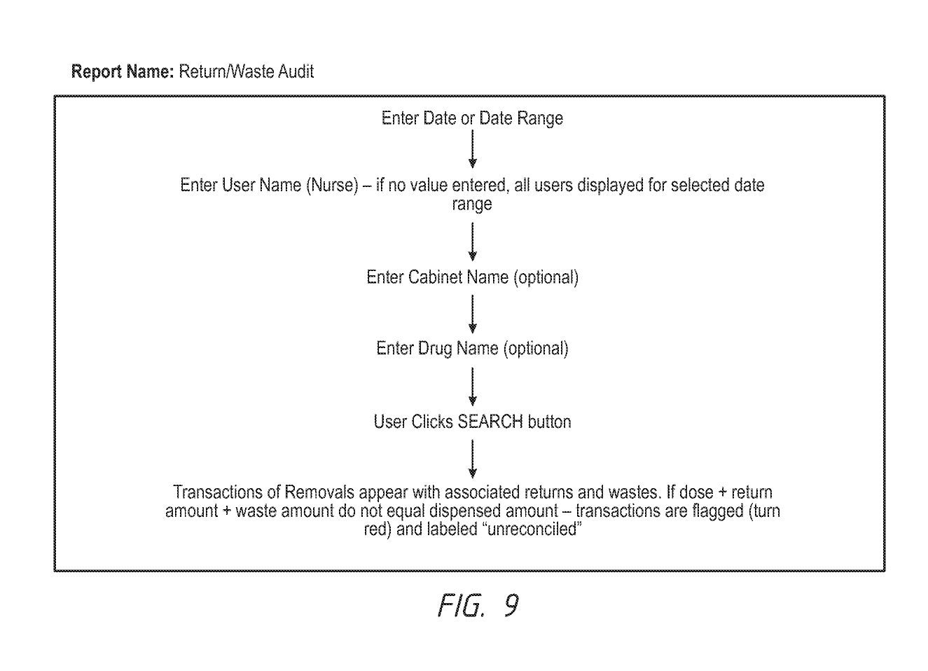

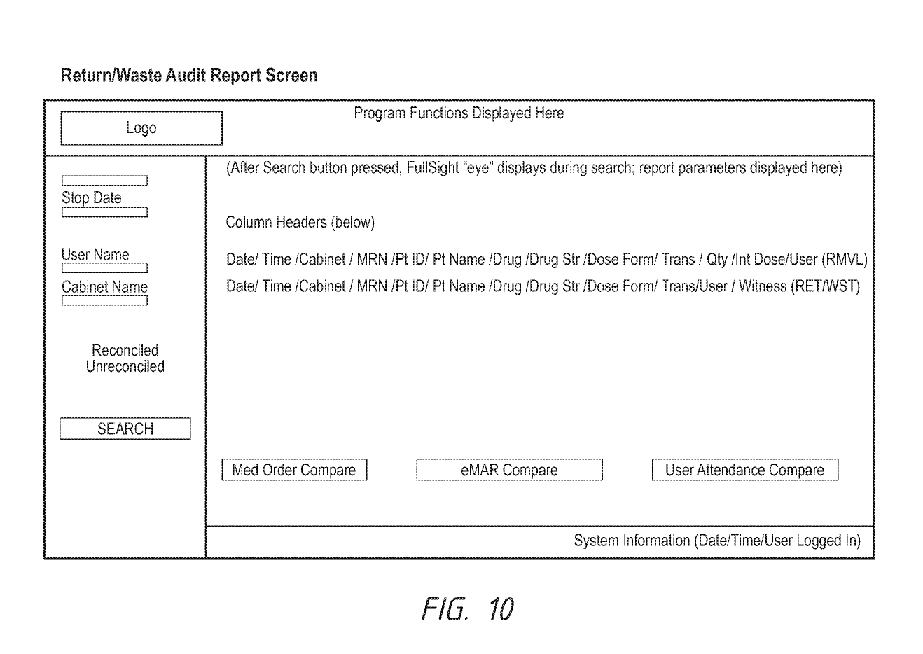

3. The Return/Waste Audit Report shows removal of doses from the ADC cabinet and compares with intended dose for the patient. FIG. 9 shows an example flowchart to generate this report. This report, FIG. 10, shows outstanding wastes for drug items removed by nurse/user. The report process matches the drug, nurse/user and patient to provide user or patient based tracking of the administration of medications. In this report, transactions of Removals appear with associated returns and wastes. This report has the additional analytic to determine if the dose+return amount+waste amount do not equal the dispensed amount, then the dispencing transactions are flagged (turn red) and labeled “unreconciled”.

### Fields Displayed and Data Types:

Date (MM/DD/YYYY)
Time (00:00-24:00)
Patient ID (Visit Number) (number)
Patient Medical Record Number (number)
Patient Name
Cabinet Name (Alpha Numeric)
Drug Name (text)
Drug Strength (number)
Drug Dosage Form (text)
Transaction Type (Removal, Return, Waste, Inventory) (Text)
Transaction Qty (Number)
Intended Dose
User Name (text)
Witness Name (if required on transaction) (text)

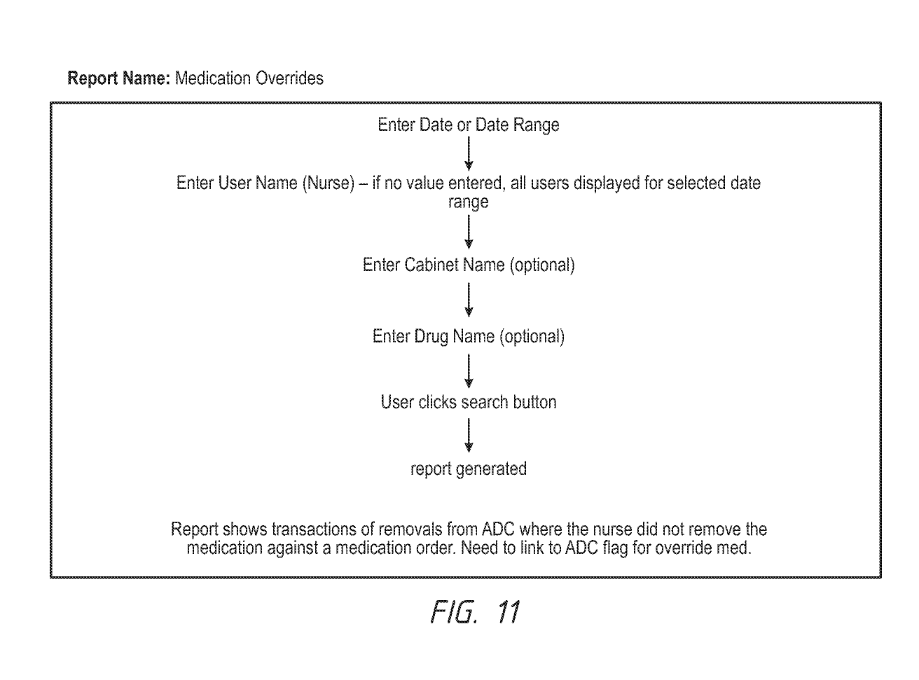

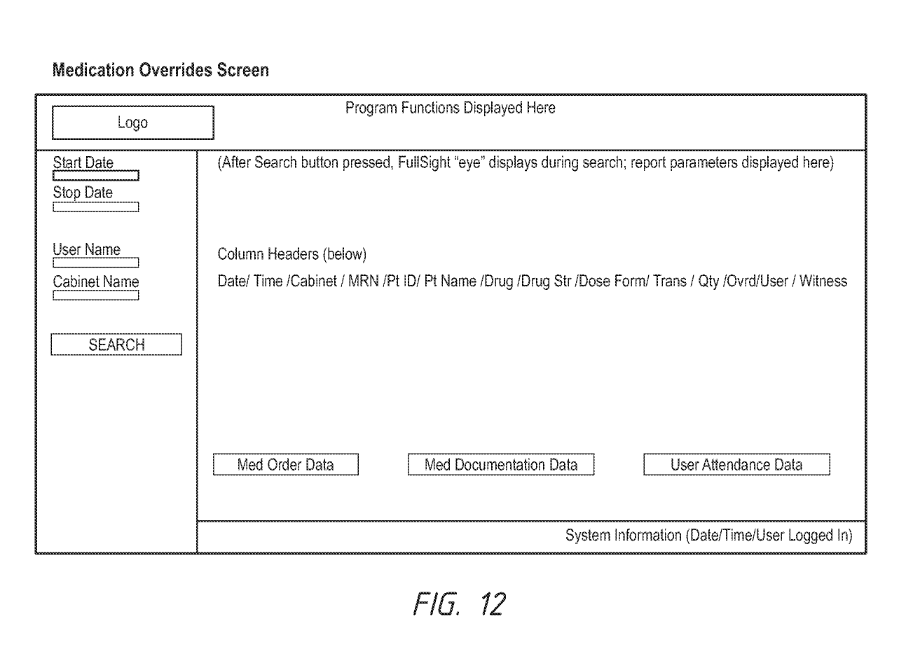

4. The Medication Overrides Report indicates the removals from an ADC that were not performed under an Order ID. FIG. 11 shows an example flowchart for generating this report. The report, FIG. 12, shows transactions of removals from ADC where the nurse/user did not remove the medication under a medication order. In this report each transaction from the ADC that does not have an Order ID or has one indicating a medical override are selected.

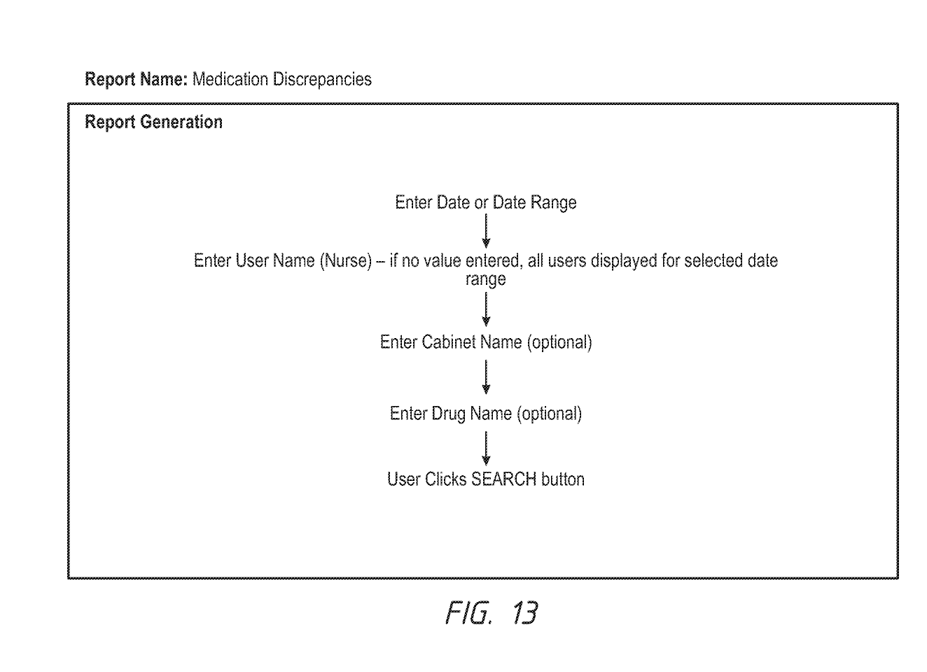

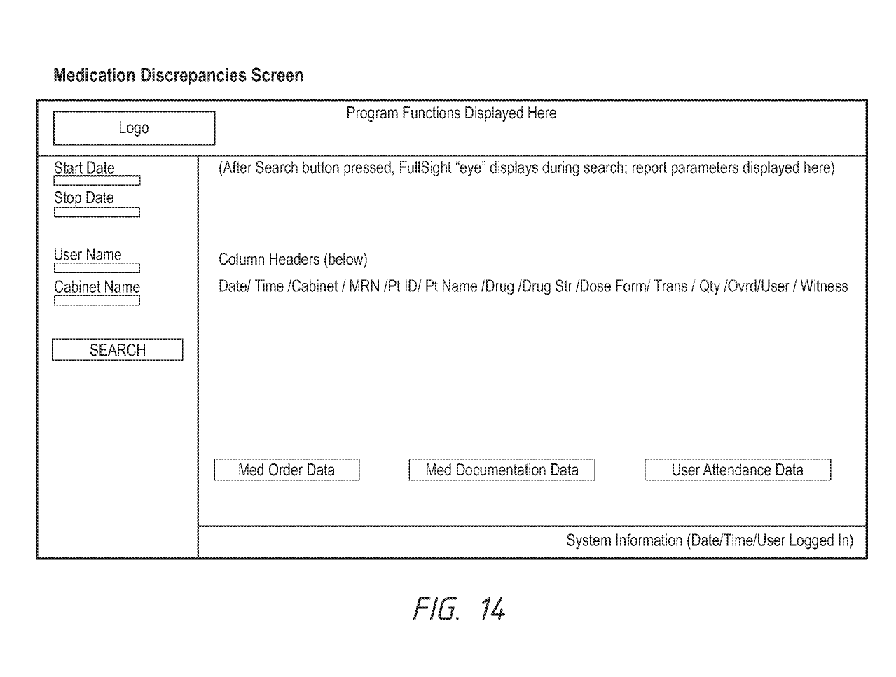

5. The Medication Discrepancies Report displays the discrepancies for medications at a particular ADC. FIG. 13 shows an example flowchart for generating this report. An example report is shown in FIG. 14.

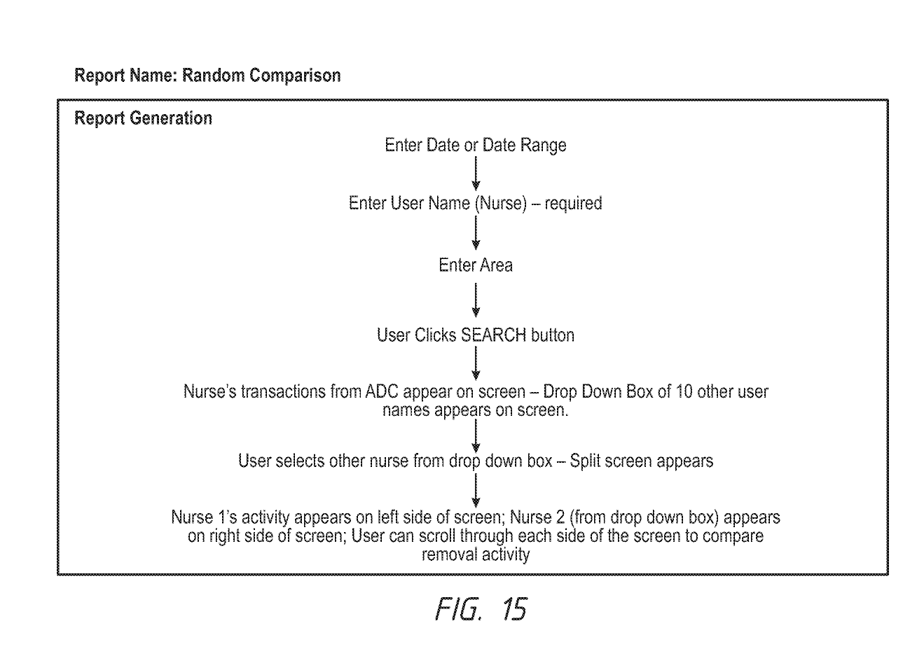

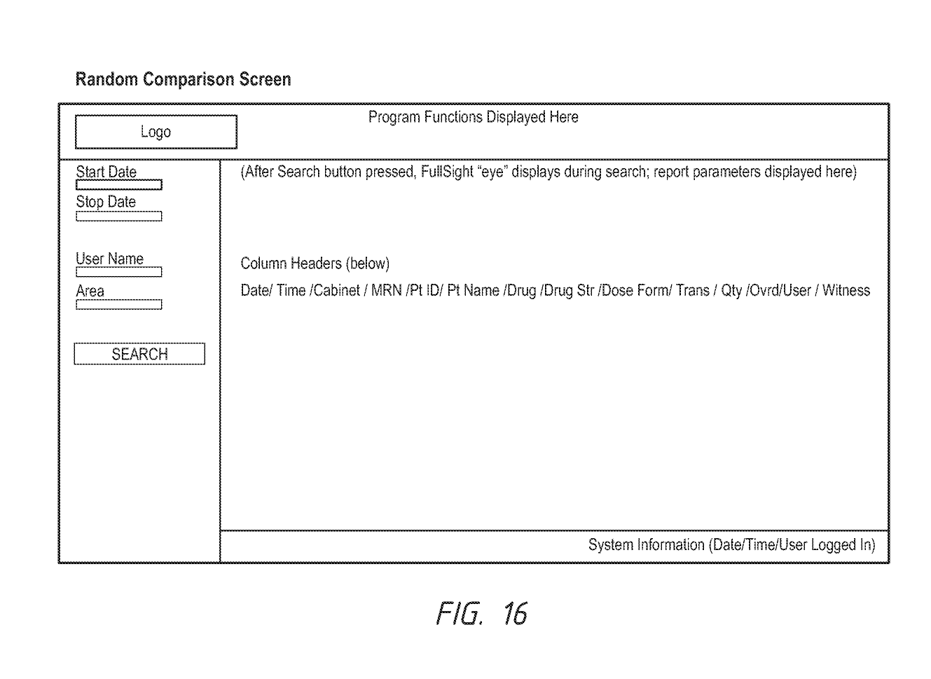

6. The Random Comparison Report shows one user's drug removal patterns compared with a predetermined number of other randomly selected users in same facility or organization. FIG. 15 shows an example flowchart for generating this report. An example report is shown in FIG. 16. Other correlating variables may be used, for example, among similar diagnosis types, or similar service setting, e.g. operating room vs. hospital room. It is expected that similar usage will be indicated for similar diagnosis patients or service settings. These may be compared to determined where there is appropriate use of the drug. This report will indicate whether one user's removal quantities exceed the number of removals by other users who are working in the same patient care area or service.

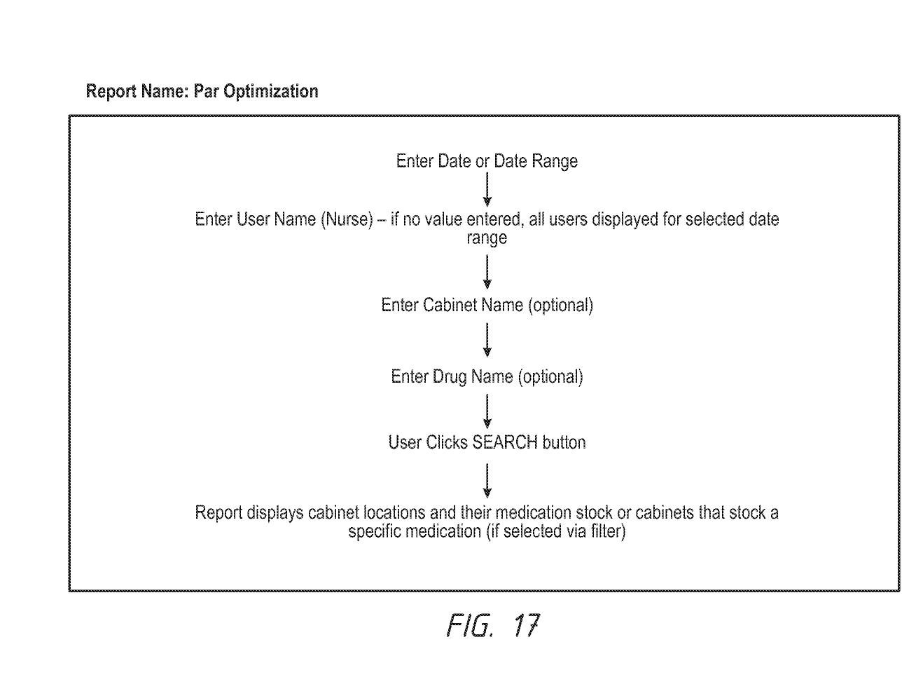

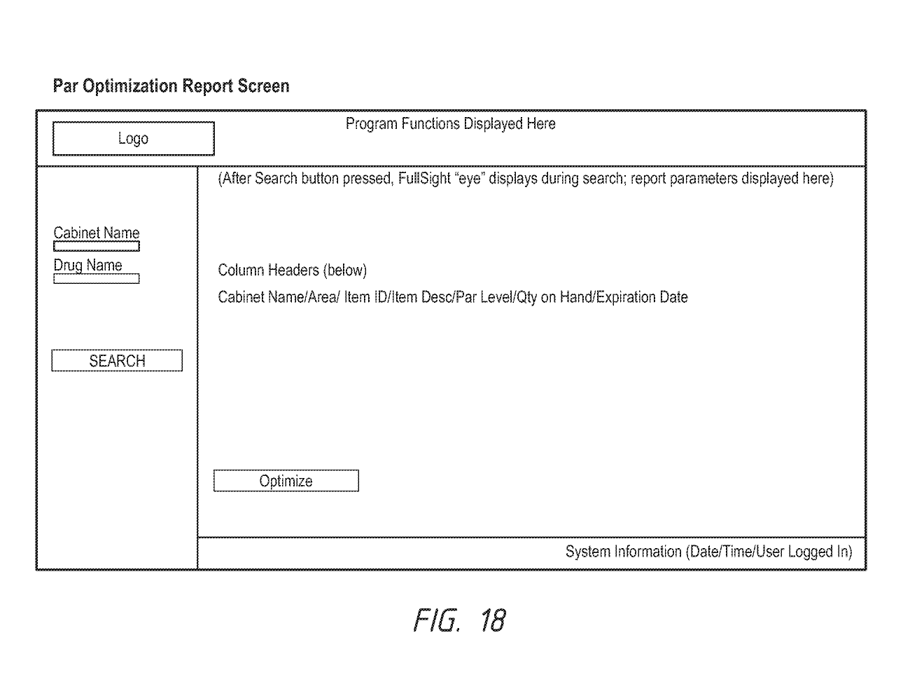

7. Par Optimization Report: This report lists the quantities on hand of drugs stocked in ADC cabinets and also provides recommendations on increasing or decreasing par levels of specific drug items based on usage statistics. FIG. 17 shows an example flowchart for generating this report. An example report is shown in FIG. 18. Report displays cabinet locations and their medication stock or cabinets that stock a specific medication (if selected via filter)

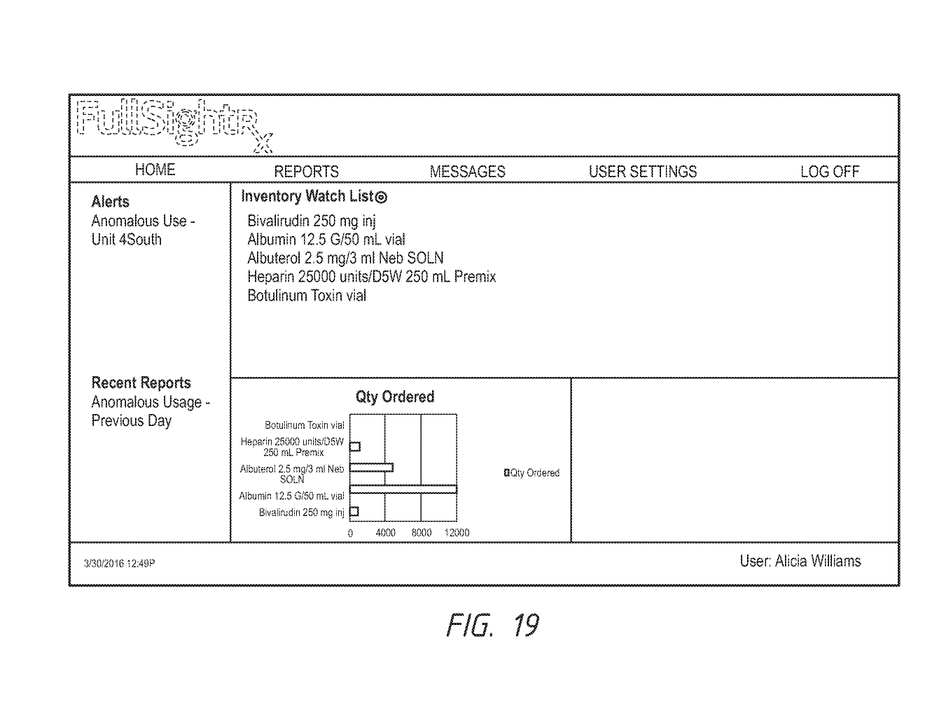

8. Inventory Watch List: This list appears on the first screen the user displayed to the user after logging into the system. FIG. 19 shows an exemplary display. The list of drug items on the screen is select by the user for monitoring. The intent of the Watch List is to allow the user to monitor the quantity of a drug dispensed or administered. It also compares these numbers to the quantity of drugs ordered. Drugs that on this list are selected from a master drug list by the user Adding Drug Item to List

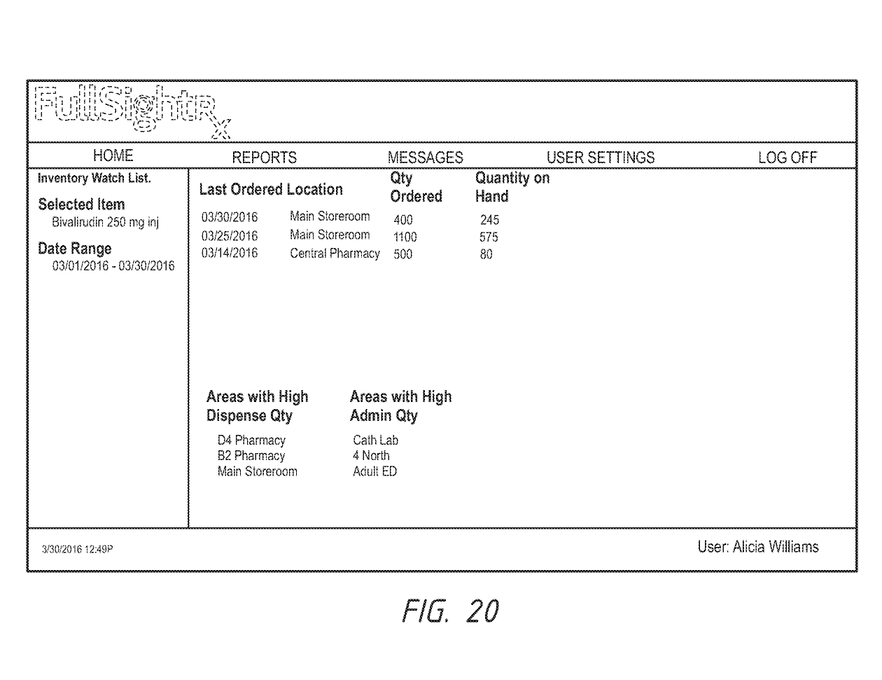

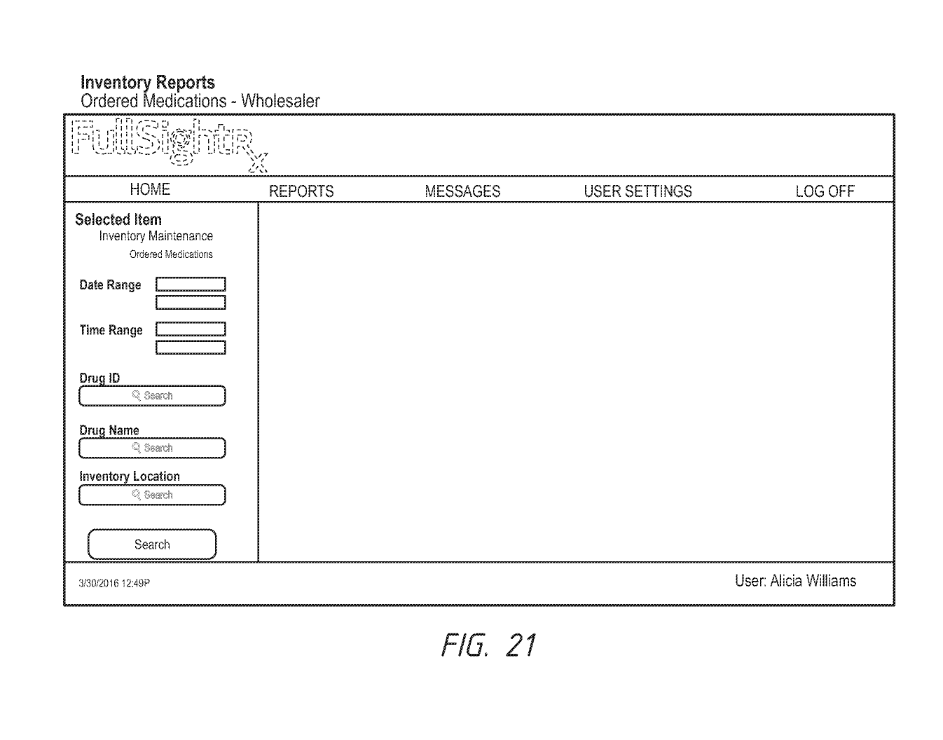

User clicks on Plus sign next to Watch List header
Drug Master List appears
User clicks on drug on master list
Selected drug appears in the Inventory Watch List section on the screen. FIG. 20 shows an example drug status report.
The system can also display the status of ordered medications, including when the orders were placed, the location of the inventory and by date range. An example display screen is shown in FIG. 21.

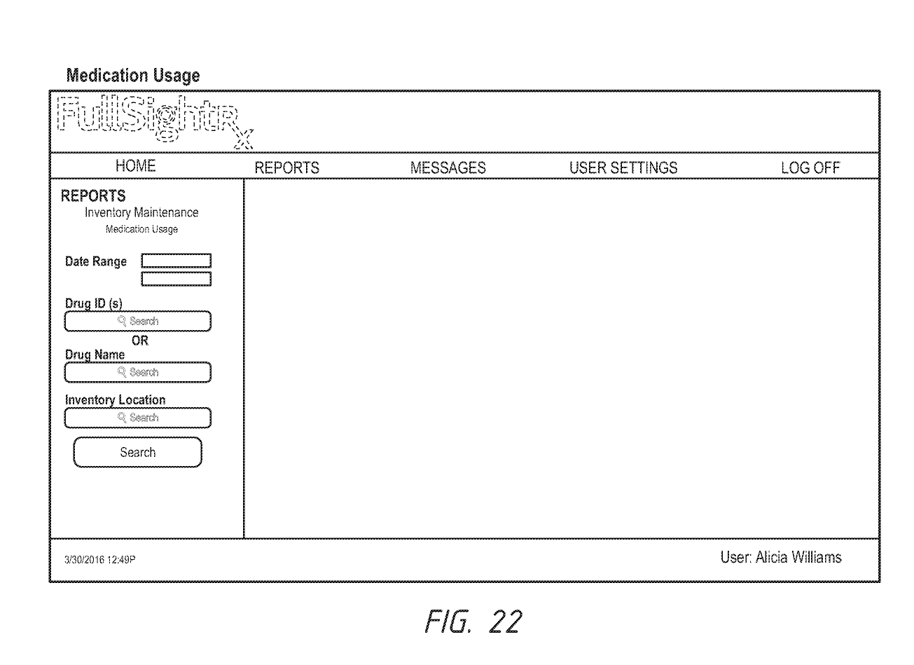

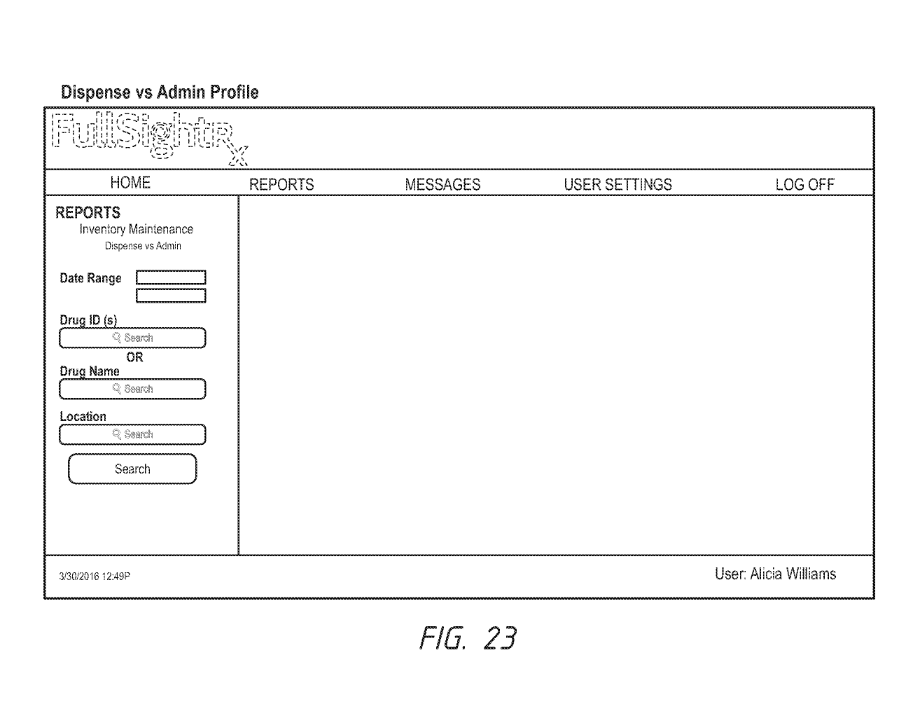

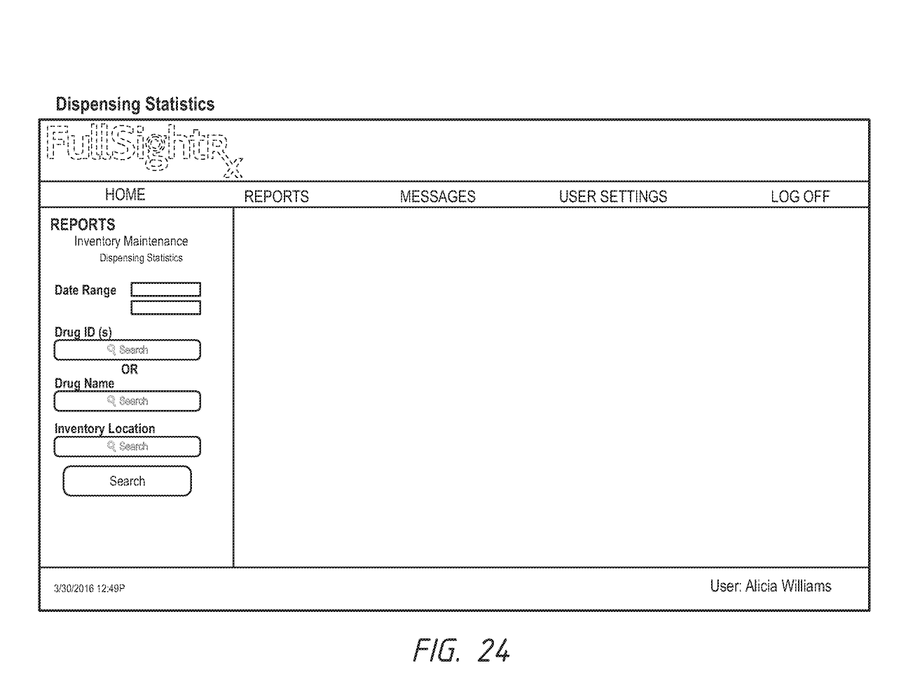

9. Alerts: This section of the first screen displays alerts for drug items that have been flagged for anomalous use. The report Anomalous Use shows users that have removed a quantity of a particular drug item from an ADC over a specified period of time that exceeds a predetermined threshold, or that otherwise is flagged due to a predetermined analytical result showing an anomaly. This particular report can be run continuously in the background in order to search for anomalous use according to alert settings created by an administrator. FIG. 22 shows an exemplary display screen for reporting medication usage. FIG. 23 shows an exemplary display screen for showing dispensed amounts of a drug as compared to a user profile. FIG. 24 shows an exemplary display screen for showing the dispensing statistics, which would show average usage during the time period, and how that usage compares to an overall average as well as standard deviation thresholds.

10. Graph: The graph report displays either anomalous use for areas monitored by the user and/or inventory items that exceed a specified limit (settings for reports done by administrator).

Inventory Watch List Report (add details on user who ordered medication, reports parameters to the banner and sorting option for columns. Can expand into more detail by clicking the line item)

### Last Ordered

Lists date the selected drug item was last ordered. Report sorted by most recent order to oldest order in the selected time period.

### Location

Displays the areas that placed the order for the medication. Includes Central Pharmacy Store Room and Satellites

### Qty Ordered

Displays the quantity ordered of the medication for the specific record.

Areas with High Dispense Quantity

Shows Pharmacy satellites that dispense the highest quantity of the medication—top 5 areas (complete list available via report). If person running the report clicks on a listed location—the details on dispensing history for that drug from that satellite or ADC will appear.

Areas with High Admin Quantity

Displays patient care areas that administered the highest quantities of medications—top N areas, N being a predetermined number. If the person running the report clicks on the listed location—details on administration history for the area over a specified period of time appear on the screen.

### System User Levels

The system is configured to have several types of users with different privileges.
1. Nurse Manager
   Generate reports
   Document investigation findings in repository Can attach report from FullSight to document investigations of diversion
   Can email reports (encryption feature for PHI)
   Repository Fields to document investigation of activity
      Can send internal correspondence with other users on the system

2. Pharmacy Manager

Has the Nurse Manager functions plus the following:
Par Level Reports
Cabinet Inventory Levels
Par vs. Usage Comparison
Drug Item Purchase HistoryCentral Pharmacy Activity—shows ordering, receiving and dispensing activities in Pharmacy Storerooms.

3. System Administrator Has the Pharmacy Manager functions plus the following:
User File Maintenance
Add users
Delete users
Modify User Roles
Reset of other users' passwords
Access to custom report writer
Schedule report generation
Maintain data retention settings
Setup access to data for specific patient care areas and functionality within program.

Operating Environment:

The system is typically comprised of a central server that is connected by a data network to a user's computer. The central server may be comprised of one or more computers connected to one or more mass storage devices. The precise architecture of the central server does not limit the claimed invention. Further, the user's computer may be a laptop or desktop type of personal computer. It can also be a cell phone, smart phone or other handheld device, including a tablet. The precise form factor of the user's computer does not limit the claimed invention. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like. The precise form factor of the user's computer does not limit the claimed invention. In one embodiment, the user's computer is omitted, and instead a separate computing functionality provided that works with the central server. In this case, a user would log into the server from another computer and access the system through a user environment.

The user environment may be housed in the central server or operatively connected to it. Further, the user may receive from and transmit data to the central server by means of the Internet, whereby the user accesses an account using an Internet web-browser and browser displays an interactive web page operatively connected to the central server. The central server transmits and receives data in response to data and commands transmitted from the browser in response to the customer's actuation of the browser user interface. Some steps of the invention may be performed on the user's computer and interim results transmitted to a server. These interim results may be processed at the server and final results passed back to the user.

The method described herein can be executed on a computer system, generally comprised of a central processing unit (CPU) that is operatively connected to a memory device, data input and output circuitry (IO) and computer data network communication circuitry. Computer code executed by the CPU can take data received by the data communication circuitry and store it in the memory device. In addition, the CPU can take data from the I/O circuitry and store it in the memory device. Further, the CPU can take data from a memory device and output it through the IO circuitry or the data communication circuitry. The data stored in memory may be further recalled from the memory device, further processed or modified by the CPU in the manner described herein and restored in the same memory device or a different memory device operatively connected to the CPU including by means of the data network circuitry. The memory device can be any kind of data storage circuit or magnetic storage or optical device, including a hard disk, optical disk or solid state memory. The JO devices can include a display screen, loudspeakers, microphone and a movable mouse that indicate to the computer the relative location of a cursor position on the display and one or more buttons that can be actuated to indicate a command.

The computer can display on the display screen operatively connected to the I/O circuitry the appearance of a user interface. Various shapes, text and other graphical forms are displayed on the screen as a result of the computer generating data that causes the pixels comprising the display screen to take on various colors and shades. The user interface also displays a graphical object referred to in the art as a cursor. The object's location on the display indicates to the user a selection of another object on the screen. The cursor may be moved by the user by means of another device connected by I/O circuitry to the computer. This device detects certain physical motions of the user, for example, the position of the hand on a flat surface or the position of a finger on a flat surface. Such devices may be referred to in the art as a mouse or a track pad. In some embodiments, the display screen itself can act as a trackpad by sensing the presence and position of one or more fingers on the surface of the display screen. When the cursor is located over a graphical object that appears to be a button or switch, the user can actuate the button or switch by engaging a physical switch on the mouse or trackpad or computer device or tapping the trackpad or touch sensitive display. When the computer detects that the physical switch has been engaged (or that the tapping of the track pad or touch sensitive screen has occurred), it takes the apparent location of the cursor (or in the case of a touch sensitive screen, the detected position of the finger) on the screen and executes the process associated with that location. As an example, not intended to limit the breadth of the disclosed invention, a graphical object that appears to be a 2 dimensional box with the word “enter” within it may be displayed on the screen. If the computer detects that the switch has been engaged while the cursor location (or finger location for a touch sensitive screen) was within the boundaries of a graphical object, for example, the displayed box, the computer will execute the process associated with the “enter” command. In this way, graphical objects on the screen create a user interface that permits the user to control the processes operating on the computer.

The invention may also be entirely executed on one or more servers. A server may be a computer comprised of a central processing unit with a mass storage device and a network connection. In addition a server can include multiple of such computers connected together with a data network or other data transfer connection, or, multiple computers on a network with network accessed storage, in a manner that provides such functionality as a group. Practitioners of ordinary skill will recognize that functions that are accomplished on one server may be partitioned and accomplished on multiple servers that are operatively connected by a computer network by means of appropriate inter process communication. In addition, the access of the web site can be by means of an Internet browser accessing a secure or public page or by means of a client program running on a local computer that is connected over a computer network to the server. A data message and data upload or download can be delivered over the Internet using typical protocols, including TCP/IP, HTTP, TCP, UDP, SMTP, RPC, FTP or other kinds of data communication protocols that permit processes running on two remote computers to exchange information by means of digital network communication. As a result a data message can be a data packet transmitted from or received by a computer containing a destination network address, a destination process or application identifier, and data values that can be parsed at the destination computer located at the destination network address by the destination application in order that the relevant data values are extracted and used by the destination application. The precise architecture of the central server does not limit the claimed invention. In addition, the data network may operate with several levels, such that the user's computer is connected through a fire wall to one server, which routes communications to another server that executes the disclosed methods.

The user computer can operate a program that receives from a remote server a data file that is passed to a program that interprets the data in the data file and commands the display device to present particular text, images, video, audio and other objects. The program can detect the relative location of the cursor when the mouse button is actuated, and interpret a command to be executed based on location on the indicated relative location on the display when the button was pressed. The data file may be an HTML document, the program a web-browser program and the command a hyper-link that causes the browser to request a new HTML document from another remote data network address location. The HTML can also have references that result in other code modules being called up and executed, for example, Flash or other native code.

Those skilled in the relevant art will appreciate that the invention can be practiced with other communications, data processing, or computer system configurations, including: wireless devices, Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” and the like are used interchangeably herein, and may refer to any of the above devices and systems.

In some instances, especially where the user computer is a mobile computing device used to access data through the network the network may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), or Unlicensed Mobile Access (UMA).

The Internet is a computer network that permits customers operating a personal computer to interact with computer servers located remotely and to view content that is delivered from the servers to the personal computer as data files over the network. In one kind of protocol, the servers present webpages that are rendered on the customer's personal computer using a local program known as a browser. The browser receives one or more data files from the server that are displayed on the customer's personal computer screen. The browser seeks those data files from a specific address, which is represented by an alphanumeric string called a Universal Resource Locator (URL). However, the webpage may contain components that are downloaded from a variety of URL's or IP addresses. A website is a collection of related URL's, typically all sharing the same root address or under the control of some entity. In one embodiment different regions of the simulated space have different URL's. That is, the simulated space can be a unitary data structure, but different URL's reference different locations in the data structure. This makes it possible to simulate a large area and have participants begin to use it within their virtual neighborhood.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as C, C++, C#, Action Script, PHP, EcmaScript, JavaScript, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The invention may be described in the general context of computer-executable instructions, such as program modules, being executed by a computer. Generally, program modules include routines, programs, objects, components, data structures, etc., that perform particular tasks or implement particular abstract data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog technologies, digital technologies, optical technologies, wireless technologies, networking technologies, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.) It is appreciated that any of the software components of the present invention may, if desired, be implemented in ROM (read-only memory) form. The software components may, generally, be implemented in hardware, if desired, using conventional techniques.

The invention may also be practiced in distributed computing environments where tasks are performed by remote processing devices that are linked through a communications network. In a distributed computing environment, program modules may be located in both local and remote computer storage media including memory storage devices. Practitioners of ordinary skill will recognize that the invention may be executed on one or more computer processors that are linked using a data network, including, for example, the Internet. In another embodiment, different steps of the process can be executed by one or more computers and storage devices geographically separated by connected by a data network in a manner so that they operate together to execute the process steps. In one embodiment, a user's computer can run an application that causes the user's computer to transmit a stream of one or more data packets across a data network to a second computer, referred to here as a server. The server, in turn, may be connected to one or more mass data storage devices where the database is stored. The server can execute a program that receives the transmitted packet and interpret the transmitted data packets in order to extract database query information. The server can then execute the remaining steps of the invention by means of accessing the mass storage devices to derive the desired result of the query. Alternatively, the server can transmit the query information to another computer that is connected to the mass storage devices, and that computer can execute the invention to derive the desired result. The result can then be transmitted back to the user's computer by means of another stream of one or more data packets appropriately addressed to the user's computer. In one embodiment, the relational database may be housed in one or more operatively connected servers operatively connected to computer memory, for example, disk drives. In yet another embodiment, the initialization of the relational database may be prepared on the set of servers and the interaction with the user's computer occur at a different place in the overall process.

It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting.

The foregoing description discloses only exemplary embodiments of the invention. Modifications of the above disclosed apparatus and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention as defined by the following claims.

What is claimed:

1. A computer system for monitoring drug use in a clinical facility comprising:
a subsystem comprised of electronic medical records corresponding to a plurality of patients;
a subsystem comprised of an automatic drug dispensing system;
an analytic subsystem comprised of logic, operatively connected by a data network to the electronic medical record subsystem and the automatic drug dispensing system that is configured to detect one or more analytical conditions of use of a predetermined drug.

2. The system of claim 1 where the analytic subsystem is further adapted to:
select data records representing electronic medical records of at least one patients;
select data records representing dispensing data for drugs dispensed to the at least one patients;
automatically determine for each of the at least one patients, whether any dispensing data for at least one drug does not match with the drug administered data comprising the electronic medical record.

3. The system of claim 1 where the analytic subsystem is further adapted to:
receive data representing a predetermined practice area;
receive data representing a predetermined drug type;
automatically calculate a series of data points representing use of the drug for a predetermined period.

4. The system of claim 1 where the analytic subsystem is further adapted to:
receive data representing a predetermined facility location area;
receive data representing a predetermined drug type;
automatically calculate a series of data points representing use of the drug for a predetermined period.

5. The system of claim 1 where the analytic subsystem is adapted by logic to:
automatically counting a first number of drug transaction records in the ADC data that have an indicator stating that a medication was given to a patient;
automatically counting a second number of drug transaction records in the EMR data that have an indicator showing an administration status as Not Given or Null;
determining if the difference between the first number and second number exceeds a predetermined threshold; and
updating a data record indicating the determination result.

6. The system of claim 5 where the analytic subsystem is further adapted to:
receive an identifier associated with a predetermined employee;
select the ADC drug transaction data records and EMR drug transaction data records where the received employee identifier is associated with selected drug transaction.

7. The system of claim 5 where the analytic subsystem is further adapted to:
determine the difference between the first number and second number individually corresponding to a plurality of employees; and
determine whether any of the corresponding differences exceed a predetermined threshold value.

8. The system of claim 1 where the analytic subsystem is further adapted to:
automatically match data records in the ADC data representing drug dose removals with data records in the EMR indicated that the removed drug dose was administered to a patient; and
update a data record with data representing the outcome of the matching step.

9. The system of claim 1 where the analytic subsystem is further adapted to:
automatically match data records in the ADC data representing drug dose removals with data records in the electronic Medication Administration Record (eMAR) that the removed drug dose was administered to a patient; and
update a data record with data representing the outcome of the matching step.

10. The system of claim 1 where the analytic subsystem is further adapted to:
automatically match data records in the ADC data representing drug dose removals and times of removal against the data records in the personnel database associated with a person referenced as the authorized user in the ADC data.

11. The system of claim 1 where the analytic subsystem is further adapted to:
sample drug dispensing data from the drug dispensing system and correlate dispensed drug amounts against electronic medical records in order to determine that the amount of the dispensed drug that was not administered to a patient does not exceed a predetermined threshold value.

12. The system of claim 1 where the system is further comprised of a subsystem comprised of personnel records and the analytic subsystem is further adapted to determine if there is a correlation of the anomalous use of the drug with a predetermined person represented in the data comprising the personnel records.

13. The system of claim 2 where the analytic subsystem is further adapted to randomly select personnel data records and to use the randomly selected personnel to select ADC dispensing data, and use the selected ADC dispensing data to determine typical drug usage metrics for the randomly selected group;
running a comparison of the determined drug usage metrics for the randomly selected group with the same drug usage metric data associated with a single person; and
output a data file representing a set of variations of the determined drug usage metrics and the drug usage metrics for the single person.

14. The system of claim 2 where the analytic subsystem is further adapted to:
receive data representing a predetermined employee identity;
automatically retrieve employee attendance data using the received employee identity;
receive data representing a predetermined drug type;
automatically calculate a series of data points representing use of the drug by the employee at the same time as employee had a predetermined status.

15. The system of claim 8 where the status is one of absent or off duty.

16. The system of claim 1 where the analytic subsystem is further adapted to detect trends in drug usage over a predetermined period of time based on at least two sample sets representing two time periods.

17. The system of claim 16 where the at least two time periods are 30, 60 and 90 days.

18. The system of claim 1 where the analytic subsystem is adapted to automatically calculate the quantity of a predetermined drug that was not given to patients or was not credited back to patients' accounts in the billing system by determining the value of [(dispensed by ADC+direct PIS delivery to patient)−(patient eMAR indicates Admin=YES)].

19. The system of claim 18 where the determining the value step is maintained as a running sum updated on each drug transaction.

20. The system of claim 18 where the determining the value step is run as a batch on a predetermined set of drug transaction data.

21. The system of claim 1 where the analytic subsystem is adapted to automatically calculate the value of a predetermined drug that was actually given to patients by determining the value of: [(Dispensed with Admin=YES)*Dollar Value of Drug Item for dosage]=Total Dollar Value of that drug Given to all of the Patients during period of data set.

22. The system of claim 1 where the analytic subsystem is adapted to automatically calculate for a predetermined practice area, the total cost of that drug item during a predetermined time period by calculating: (Total quantity of drug dispensed indicated by ADC)*Dollar Value of Drug Item).

23. The system of claim 1 where the analytic subsystem is further adapted to:
monitor ADC dispensing data as it is modified in order to detect a condition that the ADC dispensing data indicates that an amount of a predetermined drug that has been dispensed from an ADC over a predetermined period of time exceeds a predetermined threshold;
generate an electronic message upon the condition being detected; and
transmit the message to a predetermined destination.

24. The system of claim 1 where the analytic subsystem is further adapted to generate a report indicating the top predetermined number of locations with the highest rates of dispensing a predetermined drug.
